(19) United States
(12) Patent Application Publication
(10) Pub. No.: US 2015/0365652 A1
(43) Pub. Date: Dec. 17, 2015

(54) DEPTH CAMERA SYSTEM

(71) Applicant: LIPS CORPORATION, Taipei City (TW)

(72) Inventors: LING-WEI LIU, Taipei City (TW); HUNG-CHANG TSAI, Taipei City (TW)

(21) Appl. No.: 14/476,140

(22) Filed: Sep. 3, 2014

(30) Foreign Application Priority Data
Jun. 13, 2014 (TW) 103120578

(51) Int. Cl. H04N 13/02

(52) U.S. Cl. CPC H04N 13/0253

(57) ABSTRACT

The invention includes a control unit, a light source module, a sensor module with a lens and a computing unit. The light source module is electrically connected to the control unit and composed of multiple linear light sources. The sensor module receives reflective lights from the light source module and sends data of the reflective lights to the control unit. The computing unit is configured to receive the data of the reflective lights, to calculate the shortest distance between a reference point on an optical axis of the lens and an object distance to serve as a standard distance, to calculate sample distances between the reference point and sample points on the object, to calculate errors between the standard distance and the sample distances, and to correct the sample distances to be the same as the standard distance.

### BACKGROUND OF THE INVENTION

1. Technical Field

The invention relates to depth cameras, particularly to a depth camera with image correction.

2. Related Art

A depth camera can be used to control a computer through a gesture. Moreover, a depth camera can be further used to control a TV game through a body motion. This makes human-machine interaction more intuitive.

Such human-machine interaction needs a depth camera which can store a three-dimensional image into a two-dimensional format. A depth camera can measure a Z-axis distance between every shot point and the camera so that it can record three-dimensional image data.

A common method for measuring the Z-axis distance is to use the principle of time of flight (TOF). Simply speaking, a time period from a light beam emitted by a light source to be reflected by a shot point to come back to the origin can be used to calculate the Z-axis distance.

The Z-axis distance measured by the TOF principle is the distance between the lens and each shot point. Distances between a lens and sample points are obtained by a specific formula. However, in practice, such calculated distances will have an error because of an optical error of the light source. As a result, the image cannot be created on a plane. This is a primary drawback of the TOF method.

### SUMMARY OF THE INVENTION

An object of the invention is to provide a depth camera system, which can correct distance errors of sample points to create a correct planar image.

To accomplish the above object, the depth camera system of the invention includes a control unit, a light source module, a sensor module with a lens and a computing unit. The light source module is electrically connected to the control unit and composed of multiple linear light sources. The sensor module receives reflective lights from the light source module and sends data of the reflective lights to the control unit. The computing unit is configured to receive the data of the reflective lights, to calculate the shortest distance between a reference point on an optical axis of the lens and an object distance to serve as a standard distance, to calculate sample distances between the reference point and sample points on the object, to calculate errors between the standard distance and the sample distances, and to correct the sample distances to be the same as the standard distance.

### BRIEF DESCRIPTION OF THE DRAWINGS

FIG. 1 is a systematic block diagram of the invention;

FIG. 2 is an applied block diagram of the invention; and

FIG. 3 is another systematic block diagram of the invention.

### DETAILED DESCRIPTION OF THE INVENTION

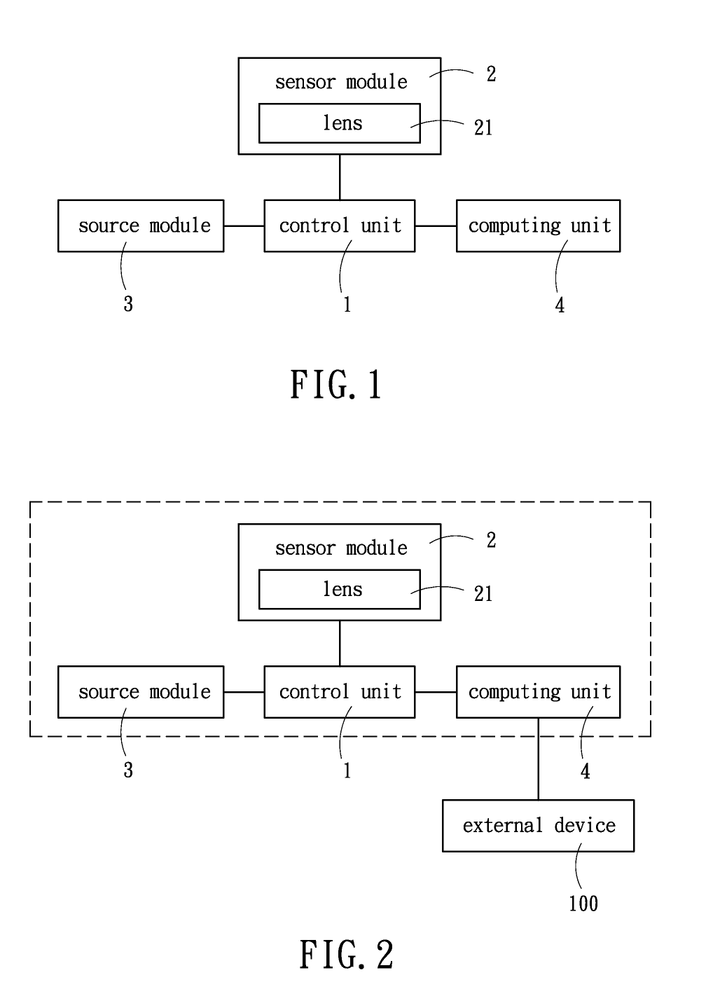

Please refer to FIG. 1. The depth camera system of the invention includes a control unit 1, a light source module 3, a sensor module 2 and a computing unit 4. The control unit 1 is electrically connected to the sensor module 2 and the light source module 3. The sensor module 2 is provided with a lens 21 for receiving reflective lights reflected by a shot object and sending data of the reflective lights to the control unit 1. The light source module 3 is under the control of the control unit 1 and associates with the sensor module 2 for emitting light beams to the shot object.

The light source module 3 is composed of multiple linear light sources such as infrared or laser light sources. The control unit 3 electrically connects to the computing unit 4. In this embodiment, the computing unit 4 is a control chip. The computing unit 4 is configured to receive the data of the reflective lights and to calculate the shortest distance between a reference point on an optical axis of the lens 21 and an object distance to serve as a standard distance. Then the computing unit 4 calculates sample distances between the reference point and sample points on the object and calculates errors between the standard distance and the sample distances. Finally, the computing unit 4 corrects the sample distances to be the same as the standard distance to create a correct image of the object. The image is delivered to an external device 100 for further application.

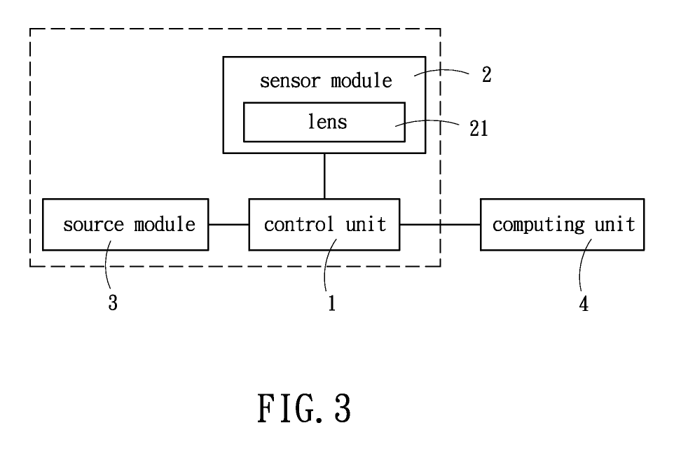

FIG. 3 shows another embodiment of the invention. In this embodiment, the computing unit 4 is an external control module, such as a computer with application programs. The computing unit 4 calculates sample distances between the reference point and sample points on the object and calculates errors between the standard distance and the sample distances. Finally, the computing unit 4 corrects the sample distances to be the same as the standard distance to create a correct image of the object. The image is delivered to an external device 100 for further application.

It will be appreciated by persons skilled in the art that the above embodiment has been described by way of example only and not in any limitative sense, and that various alterations and modifications are possible without departure from the scope of the invention as defined by the appended claims.

What is claimed is:

1. A depth camera system for shooting an object, comprising:
a control unit;
a light source module, electrically connected to the control unit, and composed of multiple linear light sources;
a sensor module, electrically connected to the control unit, having a lens, receiving reflective lights from the light source module, and sending data of the reflective lights to the control unit; and
a computing unit, electrically connected to the control unit, configured to receive the data of the reflective lights, to calculate the shortest distance between a reference point on an optical axis of the lens and an object distance to serve as a standard distance, to calculate sample distances between the reference point and sample points on the object, to calculate errors between the standard distance and the sample distances, and to correct the sample distances to be the same as the standard distance.

2. The depth camera system of claim 1, wherein the computing unit is a control chip.

3. The depth camera system of claim 1, wherein the computing unit is an external computer with an application program.

4. The depth camera system of claim 1, wherein the light sources are infrared or laser light sources.

5. The depth camera system of claim 1, wherein the light sources are linear.
